(19) United States
(12) Patent Application Publication
(10) Pub. No.: US 2013/0185234 A1
(43) Pub. Date: Jul. 18, 2013

(54) System and Method for Using Genetic Algorithm for Optimization of Targeting Systems, Based on Aggregated Scoring Models

(71) Applicants: Amrinder Arora, Centreville, VA (US); Lusine Yepremyan, Glendale, CA (US)

(72) Inventors: Amrinder Arora, Centreville, VA (US); Lusine Yepremyan, Glendale, CA (US)

(21) Appl. No.: 13/351,021

(22) Filed: Jan. 16, 2012

(51) Int. Cl. G06N 3/12

(52) U.S. Cl. 706/13

(57) ABSTRACT

In our presentation here, as examples, we describe methods and systems with various optimization techniques. More specifically, they are directed to methods for applying genetic algorithms, and the use of genetic algorithms in optimizing targeting systems that use an aggregated scoring model. In general, the genetic algorithm principle gives guidelines for constructing practical search techniques when the number of possible trials is extremely large. The examples and other features and advantages of the system and method for using Genetic Algorithm for Optimization of Targeting Systems are described.

### BACKGROUND OF THE INVENTION

This disclosure is directed to optimization techniques. More specifically, the disclosure is directed to methods for applying genetic algorithms, and the use of genetic algorithms in optimizing targeting systems that use an aggregated scoring model.

Some of the prior art references are:
E. Falkenauer, Solving equal piles with the grouping genetic algorithm, Proc. 6th Intnl. Confon Genetic Algorithms, ed. L. J. Eshelman, Morgan Kaufmann, San Francisco (1995) 492-497.
D. Goldberg, Genetic Algorithms in Search, Optimization, and Machine Learning, Addison-Wesley, Reading, Mass. (1989).
W. A. Greene, Unsupervised hierarchical clustering via a genetic algorithm, The 2003 Congress on Evolutionary Computation, 2003. CEC '03, 8-12 Dec. 2003, Vol. 2, 998-1005.
K. Deb, A. Pratap, S. Agarwal, T. Meyarivan, A fast and elitist multiobjective genetic algorithm: NSGA-II, IEEE Transactions on Evolutionary Computation, April 2002, Vol. 6 Issue 2, 182-197.
G. Syswerda, Uniform crossover in genetic algorithms. Proceedings of the Third International Conference on Genetic Algorithms. Morgan Kaufmann, 1989.
E. Eiben, et al, Genetic algorithms with multi-parent recombination, PPSN III: Proceedings of the International Conference on Evolutionary Computation, 1994, The Third Conference on Parallel Problem Solving from Nature, 78-87.
P. Bradley, The use of the area under the ROC curve in the evaluation of machine learning algorithms, Cooperative Research Centre for Sensor Signal and Information Processing, Department of Electrical and Computer Engineering, The University of Queensland, Australia, 1996.
J. R. Beck, E. K. Shultz, The use of relative operating characteristic (ROC) curves in test performance evaluation, Arch Pathol Lab Med, January 1986, 110(1), 13-20.
D. J. Hand, R. J. Till, A simple generalization of the area under the ROC curve to multiple class classification problems, Machine Learning, 45, 2001, 171-186.
M. H. Zweig, G. Campbell, Receiver-operating characteristic (ROC) plots: a fundamental evaluation tool in clinical medicine, Clinical chemistry 39 (8), 1993, 561-577.
J. A. Hanley, B. J. McNeil, The meaning and use of the area under a receiver operating characteristic (ROC) curve, Radiology, April 1982, 143, 29-36.
Genetic algorithm, Wikipedia web site, 2010.
System for utilizing a genetic algorithm to provide constraint-based routing of packets in a communication network, http://www.patentstorm.us/patents/7092378/fulltext.html
Genetic algorithm technique for designing neural networks, http://www.patentstorm.us/patents/5249259/fulltext.html
System and method for performing non-linear constrained optimization with a genetic algorithm, http://www.patentstorm.us/patents/7672910/fulltext.html
Automated predictive data mining model selection using a genetic algorithm, http://www.patentstorm.us/patents/7801836/fulltext.html
Genetic Algorithm Optimization Method, Buczak et al., US 2003/0050902, http://www.patents.com/us-20030050902.html

However, the invention and embodiments described here, below, have not been addressed or presented, in any prior art.

### SUMMARY OF THE INVENTION

In targeting systems involving complex decision analytics, a commonly used methodology is the aggregated scoring model, wherein (i) a transaction is evaluated using multiple methods and models operating on multiple aspects of the transactional data, (ii) each of these evaluations leads to a mini-output which contains numeric results, and (iii) these mini-outputs are combined to create an aggregated predictive decision.

Many strategies can be used in the combination of these mini outputs. One such strategy is to create a polynomial (referred to as the “aggregation polynomial”) of these mini-outputs that includes powers up to a certain constant, as well as logarithm functions. Coefficients of the polynomial can then be referred to as the coefficients of the aggregation strategy and can be solved as an optimization problem.

It is in this context of solving coefficients of the aggregation polynomial that we apply genetic algorithms. Since the function is a complex function, this problem is not susceptible to solution by conventional mathematical approaches. Genetic algorithms are known trial and error search strategy procedures for solving function optimization problems. The genetic algorithm is inspired by evolution and heredity, for locating high performance structures in a complex task domain. It is an iterative technique for exploring large search spaces and complex problems of the kind that lack convenient closed forms.

The general genetic algorithm procedure is defined as follows: a set of structures, called a generation, is created, which attempts to solve a particular problem. The structures are manipulated by one or more genetic operators to create a new set of structures. These new structures are evaluated on how well they solve the problem and the best are saved, thereby creating a new generation. This evolutionary process is repeated until a structure produces an acceptable solution to the problem.

As discussed in U.S. Pat. No. 5,249,259 to Harvey, genetic algorithm searches generally determine an optimum set of values, each value being associated with a pair of elements drawn from a universe of N elements, with N being an integer greater than zero, where the utility of any possible set of said values may be measured. An initial possible set of values is assembled, with the values being organized in a matrix whose rows and columns correspond to the elements. A genetic algorithm operator is applied to generate successor matrices from said matrix. Matrix computations are performed on the successor matrices to generate measures of the relative utilities of the successor matrices. A surviving matrix is selected from the successor matrices on the basis of the metrics. The steps are repeated until the metric of the surviving matrix is satisfactory.

In a traditional unstructured search, the coefficients of the aggregation polynomial would be selected by random, the performance of the newly defined system computed, the result evaluated, and the process repeated until a satisfactory result is obtained. This is equivalent to enumeration, because each coefficient selection trial is unaffected by the outcome of previous selection trials. For any but the simplest cases, it is easy to show that this is not a practical technique, because of the large number of trials required before a satisfactory set of coefficients is achieved.

In general, the genetic algorithm principle gives guidelines for constructing practical search techniques when the number of possible trials is extremely large. The fundamental requirements for solving a trial and error problem with the genetic algorithm are that the problem must be capable of being represented by some data structure and that the problem's solutions being capable of getting evaluated.

These and other features and advantages of the disclosed methods are described in the following detailed description of various exemplary embodiments.

### BRIEF DESCRIPTION OF THE DRAWINGS

FIG. 1 is a flow chart for a method for one embodiment, as an example.

FIG. 2 is the relationship between parameters in Table 1, for one embodiment, as an example.

FIG. 3 is a system for one embodiment, as an example.

FIG. 4 is a system for one embodiment, as an example.

FIG. 5 is a system for one embodiment, as an example.

### DETAILED DESCRIPTION OF THE PREFERRED EMBODIMENTS

For a general understanding of the features of the invention, reference is made to the drawings. By the way of example, the disclosed methods will be described with respect to an SSA disability eligibility system and FDA customs inspection system. It should be recognized, however, that the disclosed methods are applicable and may be implemented outside the realm of this example, as discussed here.

In the first example, an SSA disability eligibility system, with two parameters, score types and score categories, are assumed and assigned. In the SSA Disability eligibility system, score types may be, for example, inpatient, outpatient, pharmacy and other factor claims. Score categories may be, for example, policy, expert, classification, text mining and data quality rules.

In this example, each transaction is assigned a score value for each score type and score category. Score values are based on user-defined business rules.

In the system according to this invention, a data table is formed that contains score type, score category and score value for each transaction as illustrated in the table below, Table 1:

TABLE 1
A data table is formed that contains score type, score category and score
value for each transaction.

| | Score | Score | Score |
|---|---|---|---|
| Transaction # | Category | Type | Value |
| 1 | policy | inpatient | 75 |
| 1 | policy | outpatient | 34 |
| 1 | policy | pharmacy | 0 |
| 1 | policy | other | 0 |
| | | factors | |
| 1 | text mining | inpatient | 80 |
| 1 | text mining | outpatient | 15 |
| 1 | text mining | pharmacy | 88 |
| 1 | text mining | other | 0 |
| | | factors | |
| 1 | expert | inpatient | 88 |
| 1 | expert | outpatient | 23 |
| 1 | expert | pharmacy | 14 |
| 1 | expert | other | 0 |
| | | factors | |
| 1 | classification | inpatient | 19 |
| 1 | classification | outpatient | 35 |
| 1 | classification | pharmacy | 0 |
| 1 | classification | other | 53 |
| | | factors | |
| 1 | data quality | inpatient | 77 |
| 1 | data quality | outpatient | 0 |
| 1 | data quality | pharmacy | 70 |
| 1 | data quality | other | 16 |
| | | factors | |
| 2 | policy | inpatient | 12 |
| 2 | policy | outpatient | 23 |
| 2 | policy | pharmacy | 0 |
| 2 | policy | other | 44 |
| | | factors | |
| 2 | . . . | . . . | . . . |

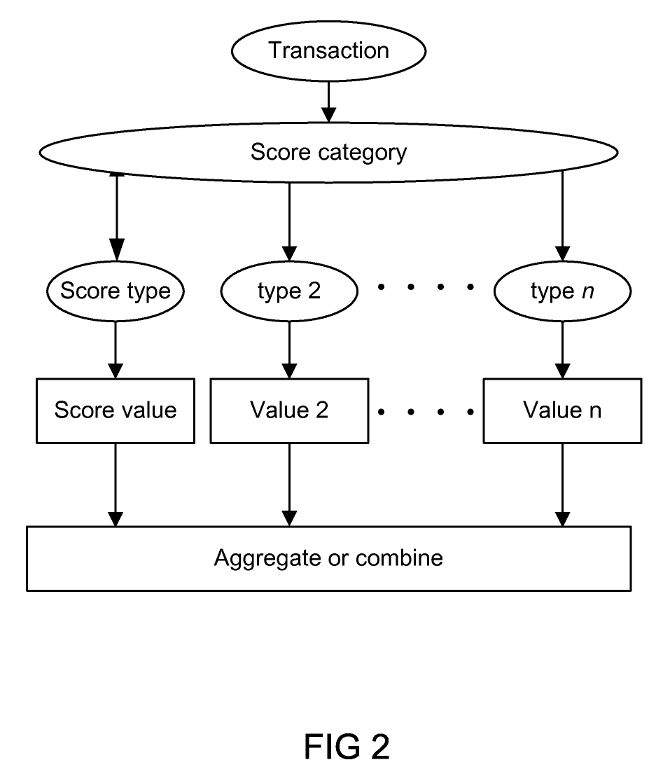

The structure above is also shown in FIG. 2, for relationships between different parameters mentioned in Table 1.

In the example above, please note that “text-mining” and “policy” both are referring to “inpatient” and “outpatient”. For example, one may want to know who was the doctor and who was the patient, as well as patient demography and occupation. Type of transactions is shown on the first column, at the left side, as 1 or 2. The particular aspect of the transaction is shown as the score category, on the second column, e.g. as “policy” and “expert”. The score category can be plotted (or visualized) against (versus) score type, as a 2-dimensional graph (with 2 perpendicular or orthogonal axes, or a 2-D matrix). Then, they can be combined logically, to form aggregate or master score.

The master score is compared against a cut-off value or threshold (master decision) (e.g. by a computer), to get values +1 (allowed) and −1 (rejected), as an example. (It is also called “predicted value” and “model value”.) The value can be evaluated manually by a person or expert or operator, or appealed by the user to authorities for modification or adjustments, if it seems improper, to be adjusted by human interactions or input.

Please note that weights are assigned to each score type and score category. This is illustrated in the table below:

TABLE 2
Weights are assigned to each score type and score category.

| Score | Score | |
|---|---|---|
| Category | Type | Weight |
| Policy | inpatient | W11 |
| Policy | outpatient | W12 |
| Policy | pharmacy | W13 |
| Policy | other | W14 |
| | factors | |
| text mining | inpatient | W21 |
| text mining | outpatient | W22 |
| text mining | pharmacy | W23 |
| text mining | other | W24 |
| | factors | |
| data quality | inpatient | W31 |
| data quality | outpatient | W32 |
| data quality | pharmacy | W33 |
| data quality | other | W34 |
| | factors | |
| Expert | inpatient | W41 |
| Expert | outpatient | W42 |
| Expert | pharmacy | W43 |
| Expert | other | W44 |
| | factors | |
| Classification | inpatient | W51 |
| Classification | outpatient | W52 |
| Classification | pharmacy | W53 |
| Classification | other | W54 |
| | factors | |

From the example above, consider a 2-D matrix (2-dimensional) with Wᵢⱼ, as weights, as entries in the matrix, from which we get the master score. Note that i and j are the indices for the 2-D matrix.

For each transaction, the weighted sum of scores is calculated, and is referred to as the “Model Master Score”. The output set of model master scores may look like, for example, as shown in the following table:

TABLE 3
For each transaction, the weighted sum of scores is calculated, and is
referred to as the “Model Master Score”.

| Transaction | Model Master Score |
|---|---|
| 1 | 34 |
| 2 | 72 |
| 3 | 54 |
| 4 | 4 |
| 5 | 118 |
| 6 | 67 |
| 7 | 190 |
| 8 | 55 |
| 9 | 71 |
| 10 | 208 |
| 11 | 12 |
| 12 | 89 |
| 13 | 88 |

While the model master scores may have a wide range, the targeting system is typically required to give its decision in two (or sometimes three) values, such as: red or green, admissible or inadmissible, accepted or rejected, or the like. The exact semantic of that output depends upon the usage of the targeting system. This translation from model master scores into predictions is typically done using a threshold or a cutoff point. For example, if a cutoff value of 80 is used, then model master scores of 80 or above may be translated into a model value of “1” (or “Accepted”, or “Red”, or the like), and the model master scores of less than 80 may be translated into a model value of “−1” (or “Rejected”, or “Green”, or the like). The output set of model values may look like, for example, as shown in the following table.

TABLE 4
The output set of model values.

| | Model Value (or Predicted |
|---|---|
| Transaction | Value) |
| 1 | −1 |
| 2 | 1 |
| 3 | −1 |
| 4 | −1 |
| 5 | 1 |
| 6 | −1 |
| 7 | 1 |
| 8 | −1 |
| 9 | 1 |
| 10 | 1 |
| 11 | −1 |
| 12 | 1 |
| 13 | 1 |

For the purpose of training the system, each transaction is classified by an empirical process (such as a manual review of chemical analysis) and the truth values are obtained. For example, the truth value (also referred to as actual value) may be based on the manual review an entity's disability application allowed or rejected status (i.e., Allowed: 1, Rejected: −1). Example of the truth values can be observed in the following table:

TABLE 5
Example of the truth values.

| | Truth Value (or Actual |
|---|---|
| Transaction | value) |
| 1 | −1 |
| 2 | 1 |
| 3 | −1 |
| 4 | −1 |
| 5 | 1 |
| 6 | 1 |
| 7 | 1 |
| 8 | −1 |
| 9 | −1 |
| 10 | 1 |
| 11 | −1 |
| 12 | 1 |
| 13 | −1 |

From the example above, the “truth value” is what it should have been. If it matches, it is “good”. Otherwise, if it does not match, it is “bad”.

The goal of a targeting system is to separate the transactions in a similar way as the empirical truth values. That is, the model values should match the truth values to the extent possible. The match between model values and truth values can be quantified, and that quantification process is discussed in the later sections.

Therefore, we observe that the set of weights affects the set of model master scores, which affects the model value, which affects the match between the model values and truth values. Therefore, a different set of weights may exist, which leads to a better match. One method for application of genetic algorithm for optimizing the targeting system, by discovering the optimum set of weights, is given here, as an example. To choose the optimum set of score type and score category weights, the genetic algorithm procedure is implemented as follows.

In step (1), an initial set of weights is formed by randomly choosing a value for each of the weights across the system captured by an objective function. The objective function is a deterministic function which determines the best values from a defined domain. In step (1) of the design procedure, the set of score types must be represented in a manner that can be easily mapped to a representation that can be subjected to a genetic algorithm operator. This mapping is achieved by formulating a representation of the score type rule firings to be designed. This formulation is called the short-term memory equation, and describes the score type rule firings by all of the inputs to that score type.

In step (2), the weight set is manipulated by a genetic operator to create a new generation of weight sets.

In step (3), each weight set, which is a member of the new generation of weight sets, is evaluated on how well its corresponding objective function responds to a set of test, or training, or input patterns in generating an expected pattern or result.

Steps (2) and (3) are repeated until a set of interconnection weights produces an objective function with an acceptable relationship between input patterns and output patterns or results.

To begin the genetic algorithm interconnection weight search procedure using the weight matrix notation, the design rules discussed above must be imposed on the interconnection weights, and thus on the interconnection weight matrix elements. With these constraints in place, the computational steps for the objective function design procedure are as follows:

1. Form a parent initial matrix set of interconnection weights which satisfy the design constraints;

2. Make copies of the parent set of matrices, and for each copy, randomly select a number of the matrix elements to be changed, subject to maintaining the above matrix properties, to produce successor matrices (offspring). In genetic algorithm terminology, a mutation operator is used to construct new generations;

3. Apply a set of input patterns to each objective function corresponding to one of the copies and solve for each objective function's output for each pattern (Note that a solution may not always exist);

4. Compute a metric to quantify the discrepancy between each of the objective function outputs and the pre-specified result;

5. Select the copy of the matrix set which provides the best objective function input/output relationship (i.e., has the smallest discrepancy metric). Make this copy the survivor;

6. Use the survivor as the parent for the next generation and repeat steps 2-5;

7. Continue until the selection criterion is met; and

8. The surviving matrix set determines the interconnection weights for the final objective function design.

In the example above, we compute the new weights. (The prediction changes (the model value changes). Then, we get the master score.) By changing match/mismatch state, we can see if we are going in the right direction (or not), and based on the feedback, if it is the wrong direction, we go back again.

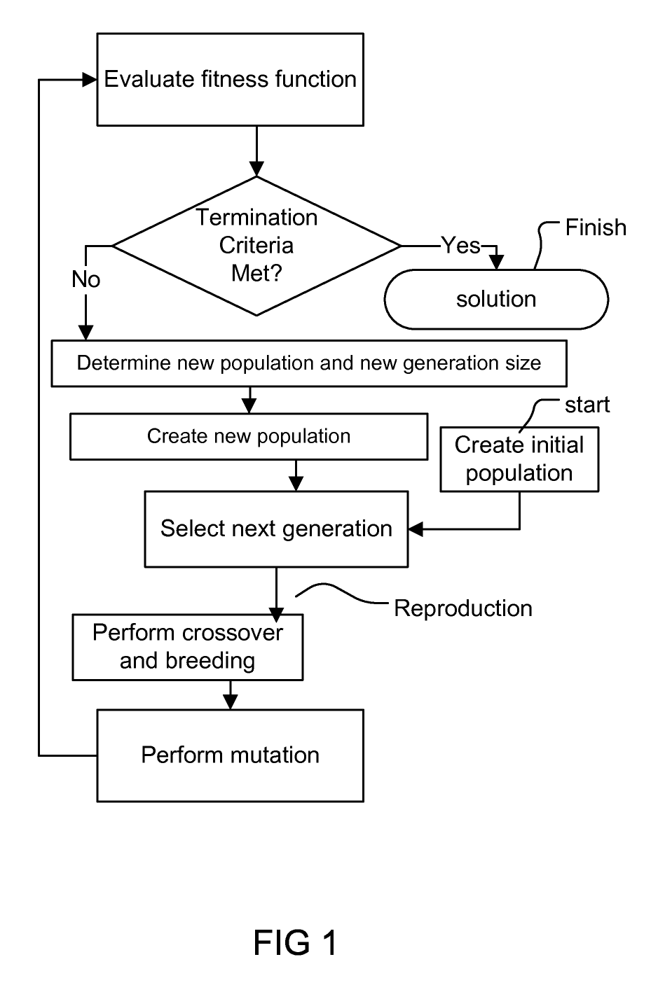

Now, the genetic algorithm will be described in detail as illustrated in FIG. 1. First, the fitness function is evaluated, and if the criteria is met, the loop is done (finished). Otherwise, the system (e.g. the computer or processor or controller or microprocessor) determines new population and new generation size. Then, it creates a new population, followed by the selection of the next generation. Note that, initially, when it created the initial population, it followed with the selection of the next generation. Then, it goes to reproduction, which includes crossover application and breeding, followed by mutation application. Later, it goes back (loops back) to the first step of fitness function evaluation.

Initial Population: Initially N vectors of weights having each element ranging from lower bound (Wmin) and upper bound (Wmax) are randomly generated to form an initial population.

New Generation: M pairs of those N vectors are randomly chosen to form a new generation. A pair is generated by randomly selecting a first vector (parent1), and randomly selecting a second vector (parent2). There is no constraint that pairs should contain different vectors, or that pairs cannot repeat. Sometimes more than two parents can be used to form a new generation.

Reproduction: An “offspring” is created from the pair of parent vectors through crossover, breeding and mutation.

Crossover and Breeding: An a vector is randomly chosen that takes values between 0 and 1 and an “offspring” is ready to be created from the pair of parent vectors as follows: first vector*α+second vector*(1−α). Alternatively, an α vector is randomly chosen that takes values of 0 and 1, and an “offspring” is ready to be created in the same fashion. Then, an “offspring” is created by adding a mutation.

Mutation: There is a lower and upper bound on Mutation size: −ε to ε. The Mutation size is being determined depending on the average Fitness of the pair. The less fit pairs are added, the higher the Mutation in absolute value.

Fitness: The Fitness Function is an objective function that prescribes a value to a solution, and thus solutions can be rank-ordered by that value. An example of Fitness Function is described in the next section.

This is related to the matching degree. For example, for higher the fitness, the higher for the possibility of the next parent selection.

Survival of the fittest/New Population: Solutions are sorted by their Fitness and a percentage (e.g. 10%) of the most-fit solutions are automatically taken into the next generation. Then, the rest of the solutions are chosen semi-randomly for parenting. The solutions with higher Fitness value get a higher chance to be selected for parenting.

For example, if we go to the wrong direction, it gets pruned out.

Adjusting Next Generation Size and the Next Population size: As generations become more and more fit, the Next Generation Size and Next Population Size are being decreased. The Next Generation Size and the Next Population size become a function of change in Fitness Function provided by best solutions of the previous population. They cannot decrease by more than their specified lower bounds.

Termination: The process is repeated, until one of the termination criteria is met:

(1) the solution does not improve by more than a delta for several generations in a row, or
(2) the number of generations exceeds W, maximum number of generations/iterations (e.g. 5000).

Comparing the predicted value to objective value and characterizing the result:

We call the value obtained by using the prediction model to be the “Model Value” and the value obtained by verifying the system objectively as the “Truth Value”.
If Model Value=1 and TruthValue=1 then we characterize this as a TruePositive
If Model Value=−1 and TruthValue=−1 then we characterize this as a TrueNegative
If Model Value=1 and TruthValue=−1 then we characterize this as a FalsePositive
If Model Value=−1 and TruthValue=1 then we characterize this as a FalseNegative

For the example above, the 4 “if” statements correspond to 4 cells. The first 2 cells are “good” cells, and the last 2 ones are “bad” cells. For the first 2 cells (corresponding to TruePositive and TrueNegative), the multiplication of “model value” times “truth value” yields +1 (corresponding to “good”). While for last 2 cells (corresponding to FalsePositive and FalseNegative), the multiplication of “model value” times “truth value” yields −1 (corresponding to “bad”).

Please note that sometimes, TruePositive is better than TrueNegative. Thus, we can assign different weights for those situations, as an example.

Calculating the confusion matrix consisting of TruePositive (TP), TrueNegative (TN), FalsePositive (FP), and FalseNegative (FN): Using the technique described in previous paragraph, we can evaluate each transaction and obtain the total number of TruePositive, TrueNegative, FalsePositive and FalseNegative characterizations.

Let's consider a 2×2 matrix, for the example above. As an example, for 100 cases, we have the first row entries as 50 and 50, and the 2^{nd} row entries as 0 and 0. The first row is the “good” row, and the 2^{nd} row is the “bad” row. This matrix indicates “good” result, and we cannot improve that any further.

For example, evaluation of 1000 transactions may result in the following confusion matrix, the table below. In this confusion matrix, there are 800 True Positives (Model Value=1 and True Value=1), 100 True Negatives (Model Value=−1 and True Value=−1), 10 False Negatives (Model value=−1, True Value=1) and 90 False Positives (Model Value=1, True Value=−1).

TABLE 6
an example for confusion matrix.

Model Values

| | | 1 | −1 |
|---|---|---|---|
| True Values | 1 | 800 | 10 |
| | −1 | 90 | 100 |

Confusion Matrix based Fitness Functions:

Fitness function can be defined as any of the following, or a combination of the following measures:
Sensitivity: TP/(TP+FN),
Specificity: TN/(FP+TN),
Positive Predictive Value: TP/(TP+FP),
Negative Predictive Value: TN/(FN+TN),
Matthews Correlation Coefficient: [((TP*TN)−(FP*FN))/SQRT((TP+FP)(TP+FN)(TN+FP)(TN+FN))]

Where (TP*TN) represents the main diagonal of the matrix, and (FP*FN) represents the other diagonal of the matrix. Also, SQRT((TP+FP)(TP+FN)(TN+FP)(TN+FN)) represents the normalization factor, for the ratio above.

ROC based Fitness Functions:

Two fitness functions that also perform well in this genetic algorithm approach are functions obtained using receiver operating characteristic (ROC) curve analysis. The analysis itself is described in the following paragraphs. The two fitness functions are:
The area under the ROC curve, where ROC is a curve for which the true positive rate (sensitivity) is plotted as a function of the false positive rate (100-specificity).
Specific region of the ROC curve (when we are interested in a segment, say lower 70%, of the ROC curve).

Note that here we can have a slider, with changing threshold, so that we can be very conservative (with no or minimum tolerance), to label all or most as “bad”, as an example.

Receiver Operating Characteristic (ROC) curve analysis:

Receiver Operating Characteristic (ROC) curve analysis is done to evaluate the performance of a model or the accuracy of a model to discriminate positive cases from negative cases. ROC curves can also be used to compare the performance of two or more models.

When we consider the results of a model in two populations, one population with positive cases, the other population with negative cases, we rarely observe a perfect separation between the two groups. The distribution of the results usually overlaps. In a Receiver Operating Characteristic (ROC) curve the true positive rate (sensitivity) is plotted as a function of the false positive rate (100-specificity) for different cut-off points. Each point on the ROC plot represents a sensitivity/specificity pair corresponding to a particular decision threshold. A model with perfect discrimination (no overlap in the two distributions) has a ROC plot that passes through the upper left corner (100% sensitivity, 100% specificity). Therefore, the closer the ROC plot is to the upper left corner, the higher the overall accuracy of the test.

One measure of the performance of the model is the area under the ROC curve. But sometimes, it can be more useful to look at a specific region of the ROC Curve, rather than at the whole curve. For example, one could focus on the region of the curve with low false positive rate.

The user can choose ROC based fitness function or confusion matrix based fitness function, as 2 different approaches here. Appendix A also graphically explains the descriptions given above, for relationship between FN, FP, TN, and TP.

Our system has a central processing unit, in one example, along with multiple storage units, with some user input interface/unit, and communication units between processing module and other modules. The data or parameters are stored in memory units, storages, databases, tables, lists, spreadsheets, physical devices or modules or units, or the like. The comparisons and calculations are done by a system, processor, computer, server, computing device, or microprocessor. The modules are connected through buffers or other memory units, with another processor directing all the data transfer and actions, as one embodiment. One can combine processors and memory units, in one or fewer units, if desired, in another embodiment.

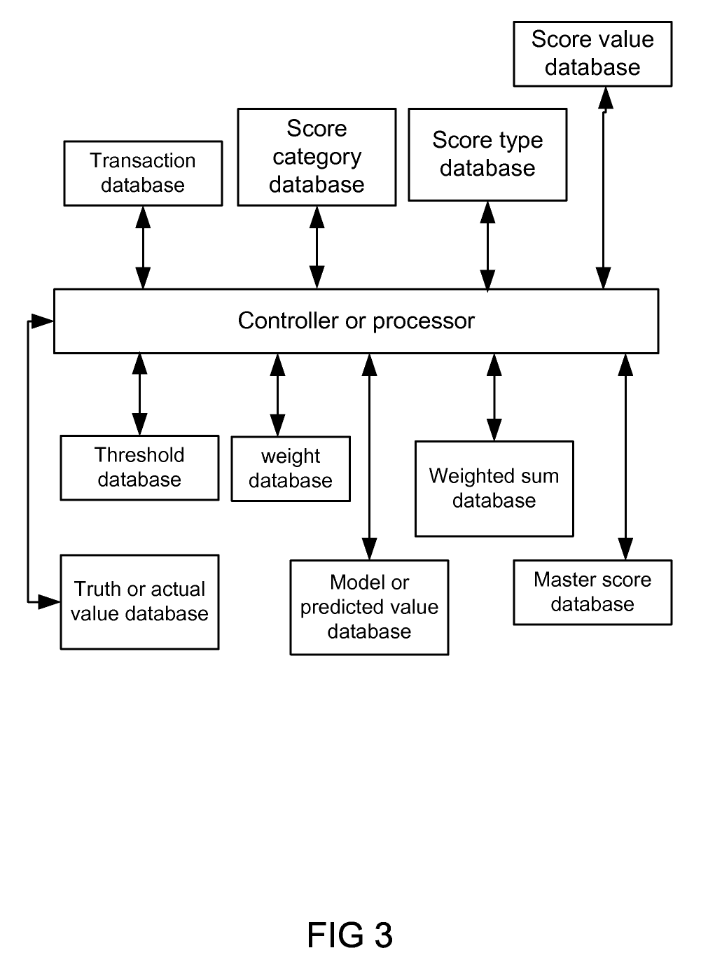

FIGS. 3-5 show some embodiment systems of our invention, as examples. In FIG. 3, we have a system comprising a processor with transaction database, score category database, and score type database, which stores the score values in a database or storage. In addition, it uses the threshold and weights (for weighted sum). It calculates the master score. Furthermore, it compares the truth value with the model value.

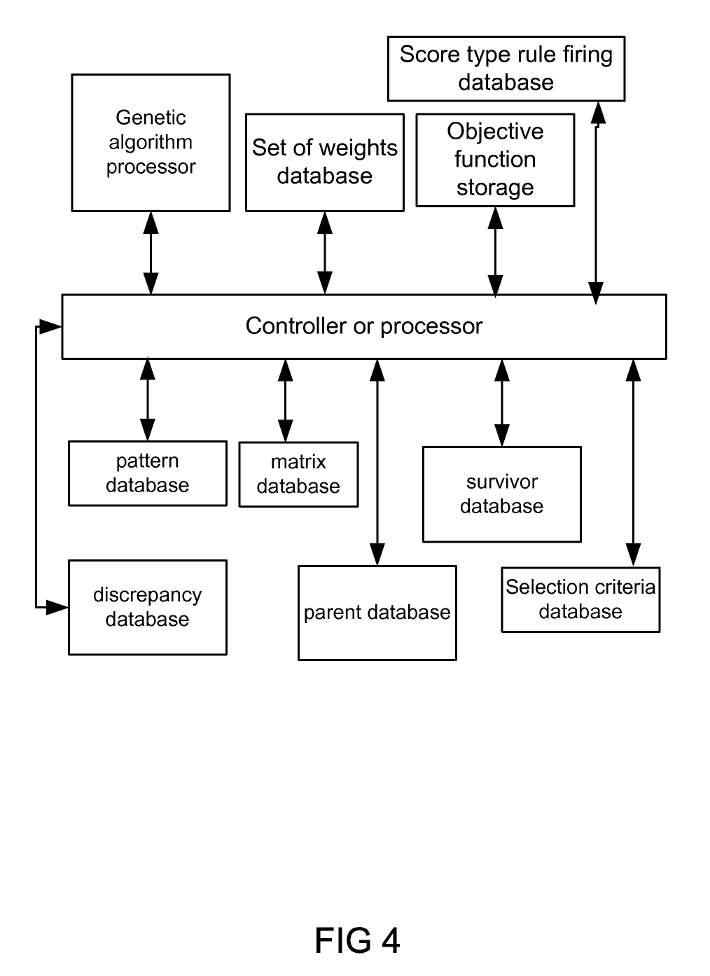

In FIG. 4, we have a system comprising a genetic algorithm processor, which uses set of weights and objective function, with score type rules and patterns. It applies matrixes for calculations, with survivors and parents determined for the genetic algorithm. It uses the selection criteria. In addition, it finds the discrepancy between each of the objective function outputs and the pre-specified result.

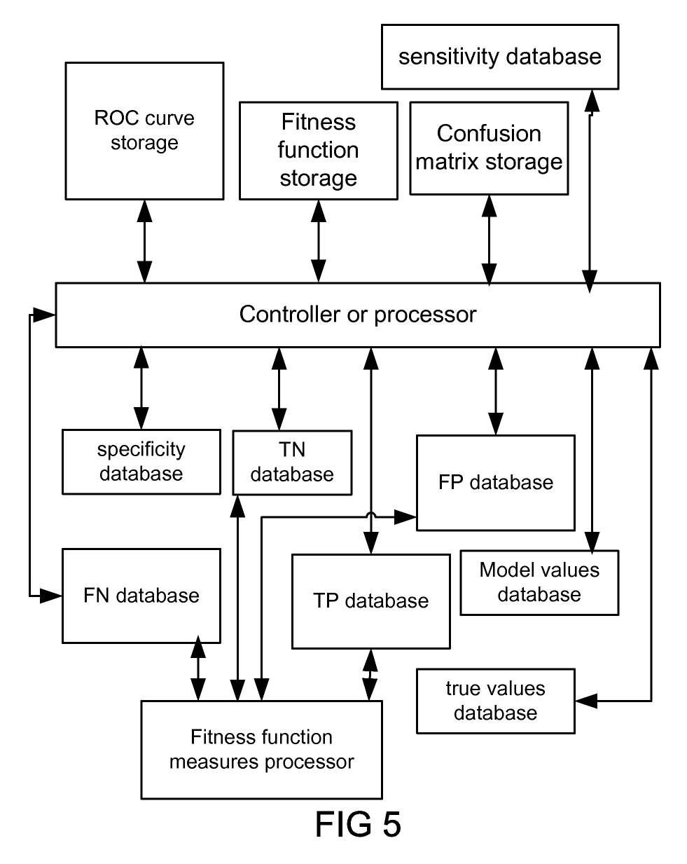

In FIG. 5, we have a system comprising a processor using and interacting with ROC curve, fitness function, and confusion matrix. It uses sensitivity and specificity as metrics or measures for fitness function, using TN, TP, FP, and FN values. It also compares true values with model values.

Any variations of the above teaching are also intended to be covered by this patent application.

1. A method of using genetic algorithm for optimization of targeting systems, said method comprising:
evaluating a fitness function by a processor or a controller;
determining if a termination criteria is met;
in a case said termination criteria is met, finishing an optimization algorithm; and
in a case said termination criteria is not met,
determining new population and new generation size,
creating new population,
selecting next generation,
performing crossover,
performing breeding,
performing mutation, and
evaluating said fitness function by said processor or said controller again.

2. The method of using genetic algorithm for optimization of targeting systems as recited in claim 1, said method comprising: aggregating scores.

3. The method of using genetic algorithm for optimization of targeting systems as recited in claim 1, said method comprising: using aggregation polynomial.

4. The method of using genetic algorithm for optimization of targeting systems as recited in claim 1, said method comprising: applying user-defined business rules.

5. The method of using genetic algorithm for optimization of targeting systems as recited in claim 1, said method comprising: using score type.

6. The method of using genetic algorithm for optimization of targeting systems as recited in claim 1, said method comprising: using score category.

7. The method of using genetic algorithm for optimization of targeting systems as recited in claim 1, said method comprising: using transaction type.

8. The method of using genetic algorithm for optimization of targeting systems as recited in claim 1, said method comprising: determining score value.

9. The method of using genetic algorithm for optimization of targeting systems as recited in claim 1, said method comprising: using threshold.

10. The method of using genetic algorithm for optimization of targeting systems as recited in claim 1, said method comprising: using weights.

11. The method of using genetic algorithm for optimization of targeting systems as recited in claim 1, said method comprising: calculating weighted sum.

12. The method of using genetic algorithm for optimization of targeting systems as recited in claim 1, said method comprising: using fitness function.

13. The method of using genetic algorithm for optimization of targeting systems as recited in claim 1, said method comprising: using confusion matrix.

14. The method of using genetic algorithm for optimization of targeting systems as recited in claim 1, said method comprising: using truth value.

15. The method of using genetic algorithm for optimization of targeting systems as recited in claim 1, said method comprising: using model value.

16. The method of using genetic algorithm for optimization of targeting systems as recited in claim 1, said method comprising: using sensitivity or specificity as metrics or measures for fitness function.

17. The method of using genetic algorithm for optimization of targeting systems as recited in claim 1, said method comprising: using receiver operating characteristic curve.

18. The method of using genetic algorithm for optimization of targeting systems as recited in claim 1, said method comprising: using Positive Predictive Value, Negative Predictive Value, or Matthews Correlation Coefficient.

19. The method of using genetic algorithm for optimization of targeting systems as recited in claim 1, said method comprising: using TruePositive, TrueNegative, FalsePositive, and FalseNegative values.

20. The method of using genetic algorithm for optimization of targeting systems as recited in claim 1, said method comprising: using matrix presentation.
